(19) United States
(12) Patent Application Publication
(10) Pub. No.: US 2018/0111865 A1
(43) Pub. Date: Apr. 26, 2018

(54) Chemically Enhanced Oil Recovery Water Processing For Discharge and Reuse

(71) Applicant: Cameron Solutions, Inc., Houston, TX (US)

(72) Inventors: Luis Eduardo Caires Fernandez, Cypress, TX (US); Daniel E. Shannon, Houston, TX (US); Georgianna Watson, Manvel, TX (US)

(21) Appl. No.: 15/335,113

(22) Filed: Oct. 26, 2016

(51) Int. Cl. C02F 9/00

(52) U.S. Cl. CPC C02F 9/00; C02F 1/285

(57) ABSTRACT

A system and method arranged to treat a produced water stream used in chemical enhanced oil recovery. The produced water stream is exposed to ultraviolet light sources that provide a radiant energy dosage that destabilizes organics. The ultraviolet-radiated stream is then passed through an adsorbent polymer media. An oxidant may be added to the ultraviolet-radiated stream ahead of the adsorbent polymer media or to an effluent stream exiting the adsorbent polymer media.

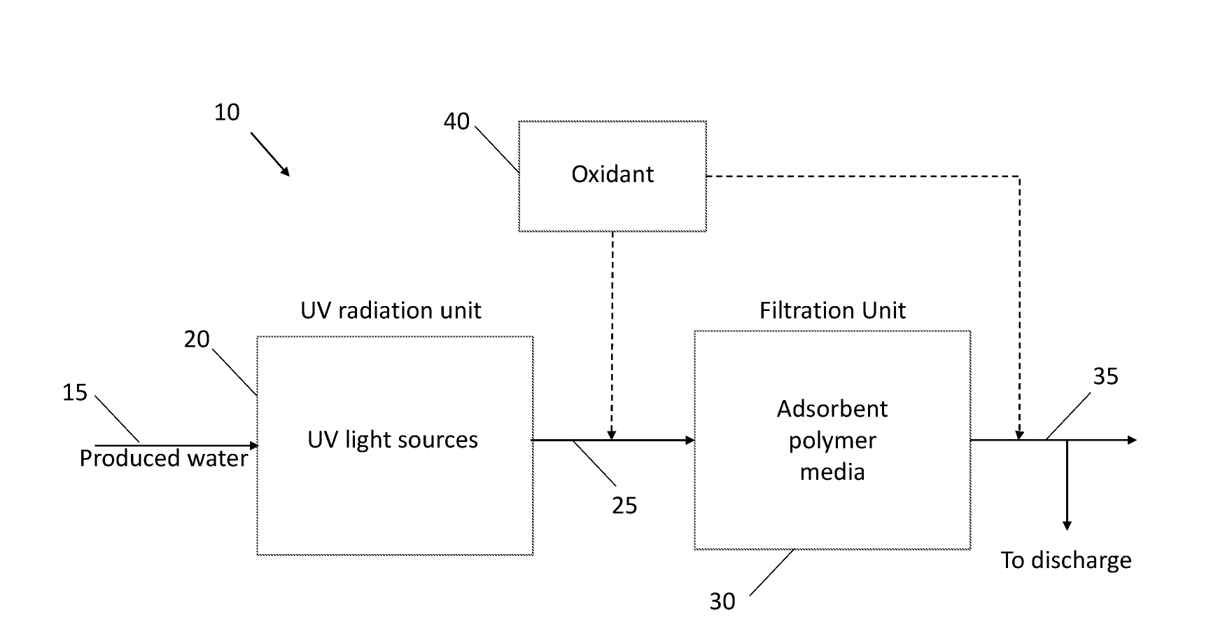

### BACKGROUND

This invention relates to systems and methods used to treat water for discharge or upcycling quality requirements after the water has been used in a chemical enhanced oil recovery application.

“Enhanced oil recovery (“EOR”) is a stage of hydrocarbon production that involves use of various techniques to recover more oil than would be possible by using only primary production or waterflooding techniques. One of these EOR techniques, chemical enhanced oil recovery (“CEOR”), and specifically polymer and alkaline surfactant polymer (“ASP”) floods, are often claimed to have the best return on investment.

In ASP flooding, alkaline chemicals such as sodium carbonate react with acidic oil components in situ to create petroleum soap, which used as one of the surfactants. A surfactant also is injected simultaneously with the alkali. A water-soluble polymer is also injected, both in mixture with the alkali and surfactant and as a slug following the mixture, to increase the viscosity of the injectant and improve mobility control of the flood fronts. This high viscosity, polymer- and surfactant-laden water must be treated to remove the residual chemicals and meet (increasingly stringent) discharge or upcycling quality requirements. (In cases where the water is to be reinjected, destruction of the residual chemicals is typically not desired.)

Chemical oxidation is employed to destroy the residual chemicals generally, followed by biological removal (and optional filtration). Use of oxidizing agents like hydrogen peroxide, ozone, chlorine dioxide, and chorine or other halogens are typically used. The oxidized contaminants are poorly biodegraded or exhibit a low value for the ratio of biological oxygen demand to chemical oxygen demand (“BOD:COD”), and not all of the contaminants are removed by this method. Additionally, the method limits the use of CEOR because of the large quantities of oxidant required, the potential for forming carcinogenic halogenated organics (if chlorine or other halogens have been used), and the broad spectrum of environmental, health and safety concerns in handling and storing these chemicals in remote operating environments.

Chemical oxidation can be supplemented by ultraviolet (“UV”) radiation or oxidation provided by UV light sources such as short wave ultraviolet lamps, gas discharge lamps, ultraviolet light emitting diodes, and ultraviolet lasers (see e.g., U.S. Pat. No. 4,849,114 to Zeff et al. disclosing chemical oxidation followed by UV radiation or simultaneous use of chemical oxidation and UV radiation; see also e.g., WO 2003/091167 A1 to Sneddon). However, as applied to CEOR produced waters, this method is not used because dissolved or undissolved salts in the produced water bend the UV light, negatively affecting the light's transmittance and effectiveness in destabilizing the oxidized contaminants.

A need exists for a system and method for treating produced waters that contain high molecular weight polymers and surfactants, uses no physical consumables for treatment, and can achieve COD limits below 80 ppm, preferably below 30 to 40 ppm, and even more preferably below 10 ppm.

### SUMMARY

A preferred embodiment of a system and method for treating produced waters that contain high molecular weight polymers and surfactants uses a combination of oxidative destruction and adsorbent polymer filtration of the chemical contaminants. The treatment means are dissociated from the condition of the continuous phase.

In a preferred embodiment of the system, an ultraviolet (“UV”) radiation unit or vessel is arranged to receive a produced water stream containing polymers and surfactants and an absorbent polymer media filtration unit or vessel is arranged to receive a UV-radiated stream exiting the UV radiation unit. An oxidant is arranged to dose the UV-radiated stream ahead of the absorbent polymer media filtration unit or the effluent stream exiting the absorbent polymer media filtration unit.

A method for processing the water includes the steps of:
exposing a produced water stream to one or more UV light sources arranged to provide a radiant energy dosage effective to destabilize organics contained in the stream;
passing the UV-radiated stream through an adsorbent polymer media; and
adding an oxidant to the UV-radiated stream immediately ahead of the adsorbent polymer media or to an effluent stream exiting the adsorbent polymer media.
   In the system and method, a UV light source is arranged to provide an effective radiant energy dosage to destabilize the organics. In one preferred embodiment, no oxidant is added ahead of the UV radiation unit or simultaneous with the exposing and passing steps.

Objectives are to provide a system and method to treat polymer and surfactant flood waters for the removal of oil and suspended solids without reducing treatment rates, treat these waters and remove residual chemical oxygen demand (“COD”), and reduce the amount of oxidant required compared to prior art systems and methods.

### BRIEF DESCRIPTION OF THE DRAWINGS

The drawing is a schematic of a preferred embodiment of the system and method.

### ELEMENTS AND NUMBERING USED IN THE DRAWINGS AND DETAILED DESCRIPTION

10 System and method
15 Produced water stream
20 UV radiation unit or vessel
25 UV-radiated stream
30 Filtration (adsorbent polymer media) unit or vessel
35 Effluent stream
40 Oxidant or oxidizing agents

### DETAILED DESCRIPTION OF THE PREFERRED EMBODIMENTS

A preferred embodiment of a system and method 10 for treating produced waters that contain high molecular weight polymers and surfactants uses a combination of oxidative destruction and adsorbent polymer filtration of the chemical contaminants. The treatment means are dissociated from the condition of the continuous phase.

Destabilization of dissolved organics is achieved by exposing a produced water stream 15 to ultraviolet (“UV”) radiation for the necessary time and with sufficient UV transmittance to drive the oxidation reaction. In a preferred embodiment, the UV radiation unit or vessel 20 includes one or more produced water inlets (and outlets) with the unit 20 sized to provide the desired exposure levels. The upper or top end of the unit 20 may be equipped with one or more oil outlets and associated skimmers.

The UV-light sources—which emit UV light preferably at a wavelength selected or optimized for the characteristics of floodwater treatment system such as flow rate, flow profile, fluid turbulence, and UV transmittance in the fluid—are spaced to provide a radiant energy dosage, in combination with the stream's residence time through the unit, to hyper-dose the stream. Computational flow dynamics may be used to optimize the light source arrangement. Dosage of UV light is defined as the mJ/cm2 required to sterilize microbes or, in this case, drive an oxidation reaction. “Hyper-dose” means a dosage of UV radiation to insure the oxidation reaction occurs irrespective of low transmittance and high flowrates. The UV-light sources may be a low, medium, or high-pressure vapor lamps, such as mercury vapor lamps (or the equivalent).

The UV-radiated (oxidized) stream 25 leaving the UV-radiation unit 20 then enters a filtration unit or vessel 30 that contains an adsorbent polymer filtration media. An adsorbent polymer filtration media like that sold by Mycelx Technologies Corporation (Duluth, Ga.) is a suitable media. The polymer does not simply filter or hold the destabilized or oxidized organics, which are no longer refractory but much more biologically degradable, it instantly and permanently binds with the contaminants upon contact through molecular cohesion.

Oxidizing agents 40 such as hydrogen peroxide, ozone, chlorine dioxide, chlorine, or other halogens may be introduced into the produced water immediately upstream of the UV radiation unit 20 or, more preferably, downstream of the UV radiation unit 20, that is, either upstream of the adsorbent polymer media where the media can remove the precipitated organics or downstream of the media to break the organics into a less toxic degradation product. Applying the agents after the UV radiation step reduces the amount of oxidant required compared to prior art methods. Applying the agents after the adsorbent polymer media step provides an even greater reduction in the amount of oxidant required. Therefore, preferably no oxidant 40 is added ahead of the UV radiation unit 20.

By combining UV radiation with the adsorbent polymer media, both simple and complex refractory organics are oxidized. Additionally, in some applications no biological removal step is required. In other applications, a minimal or limited biological removal step compared to prior art methods may be required. The system and method 10 provides an effluent 35 that can meet chemical oxygen demand (“COD”) limits well below 80 ppm and produce water suitable for discharge or upcycling quality requirements. In one preferred embodiment, a COD content in a range of, or below, 30 to 40 ppm is achieved. In another embodiment, a COD content at or below 10 ppm is achieved.

The preferred embodiments described above provide examples of the system and method. The claimed system and method are defined by the claims and include the full range of equivalents to the recited elements.

What is claimed:

1. A system to process water after its use in chemical enhanced oil recovery, the system comprising:
an ultraviolet radiation unit arranged to receive a produced water stream containing polymers and surfactants;
an absorbent polymer media filtration unit arranged to receive an ultraviolet-radiated stream exiting the ultraviolet radiation unit; and
an oxidant arranged for dosing the ultraviolet-radiated stream ahead of the absorbent polymer media filtration unit or an effluent stream exiting the absorbent polymer media filtration unit.

2. A system according to claim 1 wherein the ultraviolet radiation unit is arranged to provide a radiant energy dosage effective to destabilize one or more targeted organics contained in the produced water stream.

3. A method for processing water after its use in chemical enhanced oil recovery, the method comprising the steps of:
exposing a produced water stream to one or more ultraviolet light sources arranged to provide a radiant energy dosage effective to destabilize one or more targeted organics contained in the produced water stream;
passing the ultraviolet-radiated stream through an adsorbent polymer media; and
adding an oxidant to the ultraviolet-radiated stream ahead of the adsorbent polymer media or to an effluent stream exiting the adsorbent polymer media.

4. A method for processing water after its use in chemical enhanced oil recovery, the method comprising the steps of:
exposing a produced water stream to one or more ultraviolet light sources arranged to provide a radiant energy dosage effective to destabilize one or more targeted organics contained in the produced water stream; and
passing the ultraviolet-radiated stream through an adsorbent polymer media;
wherein no oxidant is added during the exposing and passing steps.

5. A method according to claim 4 further comprising the step of adding an oxidant to the ultraviolet-radiated stream ahead of the adsorbent polymer media.

6. A method according to claim 4 further comprising the step of adding an oxidant to an effluent stream exiting the adsorbent polymer media.

7. A method according to claim 4 further comprising the step of discharging an effluent stream exiting the adsorbent polymer media.

8. A method according to claim 4 wherein a chemical oxygen demand of an effluent stream exiting the adsorbent polymer media is below 80 ppm.

9. A method according to claim 8 wherein the chemical oxygen demand is below 40 ppm.

10. A method according to claim 8 wherein the chemical oxygen demand is below 10 ppm.
